(19) United States
(12) Patent Application Publication
(10) Pub. No.: US 2012/0067214 A1
(43) Pub. Date: Mar. 22, 2012

(54) Process of Electrostatic Recirculation for Dedusting and Gas Cleaning and Device Thereof

(76) Inventor: Romualdo Luis Ribera Salcedo, Porto (PT)

(21) Appl. No.: 12/609,682

(22) Filed: Oct. 30, 2009

(30) Foreign Application Priority Data
Apr. 30, 2007 (PT) PCT/PT2008/000024

(51) Int. Cl. B03C 3/15

(52) U.S. Cl. 95/69; 96/57

(57) ABSTRACT

Cyclones with electrostatically enhanced recirculation, comprising a collector cyclone and an entry for dirty gases, located upstream from a recirculator and a central exhaust channel (CEC) for exhausting cleaned gases. Cyclones are placed in series and have a recirculation line from the concentrator to the collector to recirculate part of the gas stream. Recirculator has means for applying a high voltage producing an ionizing electric field driving particles away from CEC, without significant particle deposition on recirculator walls. Current density in the recirculator field is below 0.1 mA/m.² Average electric field is below 2×I0⁵ V/m. Particles are driven away from CEC in the recirculator by joint action of mechanical/electrical forces, the latter deriving from particles traversing the ionized field, concentrating them in the fraction of gas stream recycled back to the collector cyclone, where a part is captured. Uses include dedusting, dry gas cleaning (for acid gases), and capturing bacteria.

### CROSS-REFERENCE TO RELATED APPLICATION

This application claims the benefit of the priority filing date in PCT/PT2008/000024 referenced in WIPO Publication WO 2008/147233. The earliest priority date claimed is Apr. 30, 2007.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

1. Technical Domain

The present invention relates to a cyclone system with electrostatically enhanced recirculation, and pertains to gas dedusting and cleaning devices. The invention also relates to a process corresponding to such system.

2. State of the Art

Cyclones and recirculation. Cyclones are dedusters used in many industries with two distinct aims: removal of particulates from gaseous streams emitted from industrial processes before being released to the atmosphere (e.g., air pollution control or product recovery), or for use as reactors for gas cleaning by dry injection of appropriate reactants (absorbents). The latter case is usually followed by bagfilters for recovery of reaction products and excess absorbents.

Industrial cyclones are of different types, but the ones most used are the so-called reverse-flow type.

Theoretically, one may increase cyclone efficiency by increasing gas entry velocity, but in practice there is a velocity limit beyond which collection efficiency decreases. This is due to saltation (Licht, 1980), a phenomenon that resembles sand saltation in dunes due to excessive winds. To reduce or even eliminate saltation, a proposal was put forward using partial recirculation of gas and uncaptured particles (as referred in the family of patents PT102392, WO0141934, U.S. Pat. No. 6,733,554, CA2394651 and EP1272278). These systems use recirculating cyclones for dedusting and gas cleaning. They are composed of a reverse-flow cyclone (collector) and a straight-through recirculating cyclone (concentrator) arranged in a series, and with recirculation characterized by the collector being upstream from the concentrator and by a recirculation loop that recirculates part of the gas being treated from the concentrator back to the collector. Recirculation is made by a venturi, blower or ejector (FIG. 1). These systems, employing the above principle of operation, are already in use at various industries (Salcedo and Pinho, 2002, 2003; Salcedo and Sousa Mendes, 2003: Salcedo et al., 2004), and are able to remove all particles above approximately 10 μm. These systems have a global efficiency given by:

$$η = \frac{{η}_{col}}{1 - {η}_{con} + {η}_{con} {η}_{col}}$$

where η_{co}i and η_{COn} are respectively the efficiencies of the collector and the concentrator.
   It is thus verified that the efficiency of a cyclone or a multicyclone (several cyclones in parallel) can be increased by recirculation and, in particular, with a system comprising a reverse-flow cyclone (collector) upstream from a straight-through cyclone (concentrator).

Electrofilters. Since the beginning of the last century (White, 1963), there exists a kind of deduster designated as an electrostatic precipitator (commonly known as ESP) that use electric forces generated by a discharge from a conductive wire connected to a high-voltage (HV) power supply, generally of direct current (dc), and located symmetrically in the axis of a cylinder (tubular ESP) or at mid distance from parallel plates (parallel plate ESP). Both cylinder and parallel plates are grounded, and the generated electric field is responsible for particle charging, with the majority of particles acquiring a charge of the same polarity as that of the discharge wire. These particles are of opposite polarity to the discharge wire, and in their trajectory throughout the ESP, are attracted to the cylinder or to the collector plates. The particles are captured there and later removed by pneumatic hammers or vibrating devices, or by an appropriate washing liquid (Oglesby and Nichols, 1978; Parker, 1997), falling in hoppers from where they are transported at a later stage.

An ESP thus needs:
one discharge electrode of reduced curvature (to achieve gas ionization at moderate voltages, in the order of 10-20 kV, depending on the temperature and composition of the flue gas), and electrically insulated from the rest of the equipment and connected to a high voltage power supply, generally of direct current (dc) up to 70 kV;
one collection electrode of large curvature (cylinder or parallel plates), grounded to earth and thus creating a large potential difference in relation to the discharge electrode;
one system to wash, vibrate or hammer the collection electrode to remove the deposited dust by gravity;
one system of dust hoppers to collect and transport the dust out of the ESP cage. In the case of tubular ESPs, of cylindrical or similar geometry (e.g. hexagonal cross-section), dust is usually removed from the walls by washing with an appropriate liquid to eliminate particle re-entrainment in the gas stream, and so these ESPs are always vertical, with flue gas entering at the bottom and leaving at the top (White, 1963; Oglesby and Nichols, 1978; Parker, 1997). In the case of parallel plate ESPs, the use of washing liquids to remove particles is less common, but the plates are almost always vertical. For a tubular ESP to work successfully, according to the traditional way, i.e. as a particle collector device, it is necessary that the following factors occur simultaneously:
   1. An appropriate high-voltage (HV) dc source must be available, which in practice corresponds to the use of lower voltages at around 60-70 kV (Parker, 1997);
   2. The discharge electrode must have a reduced radius of curvature that corresponds, for cylindrical wires, to the use of 1-3 mm diameter cylindrical wires. In practice, 2-3 mm wires are employed (Parker, 1997). The smaller the discharge wire diameter, the lower the corona onset voltage for the gas (White, 1963; Parker, 1997). However, the electric field near the collecting electrode will decrease, thus decreasing somewhat the collection efficiency;
   3. The collection electrode must have a large radius of curvature, which in practice corresponds to the use of cylindrical or hexagonal chambers, vertically disposed, where the gas enters at the bottom and exits at the top;
   4. There must be a correct spacing between the discharge and collection electrodes to produce high-strength electric fields (<<5×IO⁵ V/m) and high migration velocities of particles towards the collection electrode (<<0.1-1 m/s for particle diameters between 0.1-10 μm; Parker, 1997), with common spacings in tubular ESPs between 150-250 mm;
   5. There must be sufficient residence time (large length of collection electrode, or, in alternative, low gas velocity of flue gas to be treated), which, in practice, results in average gas velocities in the order of 1.5-2.5 m/s;
   6. There must be some ancillary means to remove deposited particles on the walls, namely through vibration, hammering or washing the walls, and the particles must be collected at the base of the cylindrical ESP;
   7. The particles must possess appropriate electrical properties, in particular with respect to its electrical resistivity (a measure of the charge removal rate from the deposited dust layer on the collection electrode), and it can neither be too low (<10⁶ Ohm−m) to avoid a very fast discharge and particle re-entrainment in the flue gas, nor too high (>10⁹ Ohm−m) to avoid the establishment of very large electric fields in the deposited dust layer (White, 1963; Salcedo, 1981) because both these phenomena will decrease collection efficiency. There are also reverse-flow cyclones (without any recirculation system) that have been directly electrified (Lim et al., 2001; Shrimpton and Crane, 2001; Lim et al., 2004) with the electric field present in the reverse-flow cyclone itself, with the objective of increasing its collection efficiency (which, in Eq. [1] is η=η_{col}.

One example of this last concept is described in U.S. Pat. No. 6,355,178 BI. In particular, looking at FIGS. 4 and 5 of this patent and corresponding description, a reverse flow cyclone for gas dedusting is described, wherein a buffer zone separates the upper zone from the bottom zone. A differential voltage is applied to these two zones with the objective of charging the particles in the upper zone and of capturing them in the lower zone wall. According to two different variants described in FIGS. 11 and 15 of this patent, there is a particle pre-charger upstream from the cyclone collector (reverse-flow cyclone) where the entire flue gas passes. Again, the objective is to capture the particles in the reverse-flow cyclone walls. In a particular arrangement (shown in FIG. 13 of the same patent), the upper part of the vortex tube is used to pre-charge the particles entering the cyclone. In another arrangement (shown in FIG. 12 of the same patent), the pre-charger is a discharge electrode inserted longitudinally in the admission pipe. Again, the objective is to capture the particles in the reverse-flow cyclone walls. Finally, in a third arrangement (shown in FIG. 14 of the same patent), the discharge electrode (a wire) is located on the cyclone longitudinal axis. The alternatives and devices discussed above usually imply the use of ancillary devices for vibrating the cyclone (by mechanical, pneumatic or electrical means), eventually complemented with vibrating means using sound waves or ultrasounds. In both cases, the goal is to allow for particle removal from the cyclone walls. Examples of these ancillary means are represented in FIGS. 16 and 17 of the same patent.

Apart from the inconvenience of having to resort to these complimentary means of vibration, since the particles are captured in the cyclone walls, it is a fact that with the alternatives depicted in FIGS. 13 and 14 of U.S. Pat. No. 6,355,178, the effect of the particle charging devices is expected to be very small; This is because in the usual dimensions of a cyclone, the charging devices do not have sufficient length to assure significant particle charging. In the case of the third configuration referred above, the exposed part of the discharge wire cannot be too close to the cyclone bottom because arching will be produced between the discharge wire and the cyclone wall. Increasing the lengths (or heights) of the discharge elements to increase particle charging will proportionately increase cyclones to much encumbering sizes or lead to a geometry far from high-efficiency cyclones (i.e., intrinsically less efficient). Furthermore, an application of such devices for solving industrial dedusting problems is not known (and not merely at laboratory or pilot-plant scales).

Agglomerators. U.S. Pat. No. 4,718,923 pertains to an electrostatic agglomerator for soot particles in a flue gas to increase particle size (by promoting interparticle agglomeration) and their subsequent removal by a centrifugal device such as a cyclone. The entire gas stream passes first through electrostatic agglomerators, with electrostatic tube agglomerators in parallel, and next (along with the entire gas flowrate), through centrifugal collectors, such as a parallel arrangement of cyclones (eventually of the reverse-flow type). The cyclones are arranged in parallel and corresponding with the agglomerating tubes, and are located downstream from them. The agglomerating tubes are bipolar, and each comprises a discharge electrode located longitudinally with transversal plates connected to a negative polarity and electrically insulated from the tube itself, which in turn has a positive polarity. A large potential difference is established between both poles. Although the physical principle underlying the operation of this device is not described in the document, it is probable that particle agglomeration occurs first by particle deposition at the tube walls for a certain period, and next by releasing the agglomerated particles through some vibration or equivalent mechanical action. Be that as it may, inter-particle agglomeration with an increase in size is the aftersought effect as may be visualized from the figures of this patent.

Since centrifugal collectors are more efficient for the separation of larger particles (larger mass), the underlying idea to such a device is to cause an increase in the size of particles through agglomeration before passing them through the centrifugal collector. The totality of the gas stream that enters the centrifugal collector (such as a reverse-flow cyclone) is previously processed by the agglomerator located upstream from the collector. The cleaned gas exiting from the centrifugal collector is entirely exhausted without any type of subsequent recirculation, either partial or total.

The same principle applies to the functioning and design of the device described in U.S. Pat. No. 5,458,850. U.S. Pat. No. 6,004,375 also pertains to a particle agglomerator. No recirculation is foreseen. As in other agglomerators, the problem lies in agglomerating particles in such a manner as to increase their dimension in order to capture them more easily at a later stage. It is also intended to control the features of the agglomerated particles obtained, in terms of their concentration, structure, and dimension. The device is bipolar and the electrodes are pairs of opposing needles set radially to the gas flow. In this way, in the event of an incomplete combination of the inversely charged particles, a deviation of the particles in the radial direction is avoided.

Scrubbers. There are well known specific scrubbing devices that use dry injection of reacting powders, but that have high investment and operational costs (Carminati et al., 1986; Heap, 1996) when compared to cyclones that are used as reactors for the same purpose (Fonseca et al., 2001).

Objectives of the invention. The objective of the present invention is to provide a highly efficient process and device for gas-solid separation, showing a significantly increased efficiency, especially for removing particles of a diameter smaller than 10 μm when compared to the devices described in document WO0141934.

It is also intended that such a device may efficiently operate with particles beyond the range of particle resistivity that is typical of ESPs (i.e., outside the interval [10^{s}; 10⁹] expressed in Ohm−m), and be of simple construction, versatile and of low cost, especially when compared to ESPs. The invention would suppress the need for devices for particle removal from the collector walls existing in ESPs. An additional objective is to have operational costs that are the same as, or even below, those of the recirculating systems described in WO0141934. Another objective is that the investment costs (production and assembly) be lower than those of the current art in terms of comparable collection efficiency, and that the device according to the invention may be used for dry cleaning and/or treatment of gases at high temperatures. Also it is an objective that the encumbering be compatible for typical industrial applications and comparable to the size of the device described in WO0141934, without losing the ability to change the concentrator layout from vertical to horizontal if layout limitations at the industrial site are imperative (contrarily to what happens in tubular ESPs).

It is also an objective of the proposed invention to provide a highly efficient process for dedusting with a broad spectrum of applications, notably on the admissible resistivity range of particles to be removed from gaseous streams.

It is a further objective of the proposed invention to have acid dry gas cleaning and particulate removal from flue gases, and efficient removal of particles from exhaust gases in diesel engines.

Additional objectives will appear from the remaining description and from the claims.

### SUMMARY

Contrary to agglomerators, whose principle is to cause an increase in particle size to enhance the subsequent collection capability in particle separators (notably on centrifugal dedusters), and contrary to ESPs (or even electrified reverse-flow cyclones), whose principle is to separate particles present in the gas stream and capture them on the very electrified device, the present invention implies a device similar to that of patent WO0141934 but in which the concentrator is designed as an electrostatic recirculator.

It well established that, although the main components of the device are essentially the same as those of the state-of-the-art, i.e., a reverse-flow cyclone (collector) placed upstream from a straight-through cyclone (concentrator) and an electrostatic recirculation, the objective is not to capture particles in the recirculator (straight-through concentrator) nor to promote inter-particle agglomeration. Instead, the objective is to concentrate the particles in the recirculation stream back to the reverse-flow cyclone (the only collector), thereby significantly increasing the term η_{con} in Eq. [1], which will allow significant improvements in global efficiency (77) well above those of mechanical recirculation alone. This addition to the straight-through cyclone (concentrator) transforms it into an electrostatic recirculator as schematically shown in FIG. 2.

Although in this schematic representation there is an apparent similarity between the electrostatic recirculator and a conventional cylindrical ESP, this similarity is purely an illusion. In fact, it would be extremely counterproductive to use the recirculator as an ESP because particle capture in its walls should be minimized, or preferably eliminated, while in ESPs it should be maximized. With electrostatic recirculation, the only objective is to clear the particles from the exhaust channel located in the axis of the recirculator, making them approach the recirculator walls (without capturing them on such walls) so that they become concentrated on the tangential exit, which is the return loop to the reverse-flow cyclone (collector). Thus, the recirculation efficiency may be enhanced by implementing a dc electric field in the recirculator (concentrator), as long as the discharge and collection electrodes are designed to prevent the recirculator from operating as an ESP, i.e., to prevent or minimize particle deposition in its walls.

In sum, one may say that, if the electrostatic recirculator as per the invention were to operate as an ESP, the (partial) recirculation of flue gases to the reverse-flow cyclone (collector) would become essentially useless. Furthermore, the device would inherit disadvantages associated with ESPs outlined above, i.e., the need of vertical placement (tubular ESPs), the need to provide for complex ancillary means for removing particles, and the limitation on the type of particles susceptible of capture due to their electrical resistivity (usually limited to a relatively tight range).

On the other hand, the use of any electric field directly on the collector cyclone, as per U.S. Pat. No. 6,355,178, is inconvenient due to the factors outlined above.

According to the innovative approach of the invention, one can obtain dedusters comprised of cyclones that are simultaneously more efficient than those existing in the marketplace, with similar investment and handling costs, confined to a limited size, and that may be used at very high temperatures or for dry gas cleaning. The latter answers to ever stricter legal emission limits.

The present invention achieves the main objective of increasing the collection efficiency of cyclone systems with recirculation, resorting to electrical forces to concentrate particles that escape the reverse-flow cyclone (collector) near the recirculator walls, while minimizing particle deposition on such walls. The stream concentrated in the particles exits the recirculator tangentially, and the recycled gas fraction (<<20 to 30%) is directed back to the collector cyclone.

The present invention also contemplates providing a process of increased efficiency for gas-solid separation, as well as a process of increased efficiency of dry gas cleaning from industrial flue gases.

According to the process of the invention, the flue gases enter a reverse-flow cyclone (collector) that captures a fraction of incoming particles, and are next directed to a straight-through cyclone concentrator (recirculator) having a central channel for the exhaust of cleaned gases. There, part of the particles remaining in the flow are concentrated and recirculated, with part of that flow going back into the collector cyclone. Such a process is characterized in that the particles entering the concentrator are being directed away (deviated) from the central exhaust channel by a combination of mechanical (inertial) and electrical forces, the later being the result of particles crossing an ionized high-tension electric field. The deviation leads to the concentration of particles, without depositing them on the concentrator wall, in the part of the flow that is redirected to the reverse-flow cyclone where some fraction of them gets collected. As such, the increase in efficiency is obtained by increasing the fraction of particles that are recirculated back to the reverse-flow cyclone (collector). Thus, one increases η in Eq. [1] by increasing η_{Coni}− by inserting electrical forces in the recirculator (concentrator), and adding to the mechanical forces that exist in the concentrator of the device described in WO0141934. However, paradoxically, if instead of a recirculator (concentrator) one used an ESP, the particles would be captured on such ESP, and as such, the fraction of particles returning back to the reverse-flow cyclone would be close to zero. This means that the system would no longer function according to Eq. [1] and global efficiency would be very similar to that of the ESP, without the need to have a reverse-flow cyclone and recirculation loop. Adding to this, one would have the vast majority of disadvantages pertaining to ESPs.

Therefore, it has been determined that, according to the invention, the mentioned objectives are reached using recirculating cyclones for dedusting and dry gas cleaning comprising a reverse-flow collector cyclone and a straight-through concentrator cyclone (recirculator) with a central channel for the exhaustion of cleaned gases, wherein these cyclones are in a series and with recirculation, with the collector placed upstream from the concentrator, and with a recirculation line for part of the flow being processed from the concentrator back to the collector, characterized in that, in the recirculator there are electrical means for applying high voltage, producing an ionizing field which will impart a net velocity component to the particles traveling through the concentrator towards the wall without promoting their deposition on such wall.

According to the invention, the electrical means for applying high voltage are constituted by one or more electrical discharge electrodes located according to the longitudinal axis of the concentrator (recirculator), crossing the recirculator wall and electrically insulated from it by known methods, where the wall itself is grounded in order to create a high voltage difference between this wall and the discharge electrode(s). The voltage applied to the discharge wire, the diameter of the discharge electrode(s), and the distance between the discharge electrode(s) and the wall of the concentrator, which in turn depends on the nominal diameter (D₂) of the concentrator, are combined so that the current density at the wall is less than 0.1 mA/m². The discharge electrode may assume the shape of a conductive wire.

Even if the main objective according to the invention is to recycle back to the reverse-flow cyclone (collector) the uncaptured particles, one expects that, due to the larger particle concentration near the recirculator walls, it may be necessary and even beneficial to recycle a lower gas fraction (=>>20 to 30% against 30-40% used for purely mechanical recirculation), so that the operating costs will be lower, since the electrical forces only act on particles and not on the gas. In fact, whereas to recycle 30-40% of a gaseous stream of 50,000 m³/h one needs about <<18-25 kW of power in the recirculation blower, to recycle 20% of the same stream only 12 kW are needed, already including the electric power required to establish electrostatic recirculation through an ionized field. The savings in electric power are higher than 35%, which is significant.

So, it is also paradoxical that, while the proposed invention adds high voltage electrical components to the exclusively mechanical recirculation system described in WO0141934, the total power consumption is actually lower.

### FIGURES

FIG. 1 is a schematic representation of an all-mechanical cyclone recirculation system.

FIG. 2 is a schematic representation of the device according to the invention.

FIG. 3 represents a graph of global efficiencies (η) for the system of FIG. 2.

FIG. 4 represents a graph of grade efficiencies for the concentrators of FIGS. 1 and 2 (curves 1 and 2, respectively).

FIGS. 5 and 6 show how different geometries (resulting from interelectrode distances) of the electrostatic concentrator according to the invention (continuous line) make it so different from a traditional ESP (dots).

FIGS. 7-8 show the differences of efficiencies obtained between high-efficiency cyclones, following EP0972572, standing alone (0), cyclones according to WO0141934 with purely mechanical recirculation (1) and cyclones according to the invention (2).

FIG. 9 shows the different cut-diameters for the devices of FIGS. 7-8.

FIG. 10 shows the average increase in capture efficiency obtained by the device according to the invention (2).

FIGS. 11-13 show the increase in efficiency obtained in pilot-scale experiments with three different types of particles.

FIG. 14 shows the comparative result between a stand alone inverted-flow cyclone (0), a merely mechanical recirculation cyclone device (1) and a device according to the invention (2), for capturing airborne bacteria.

### DESCRIPTION

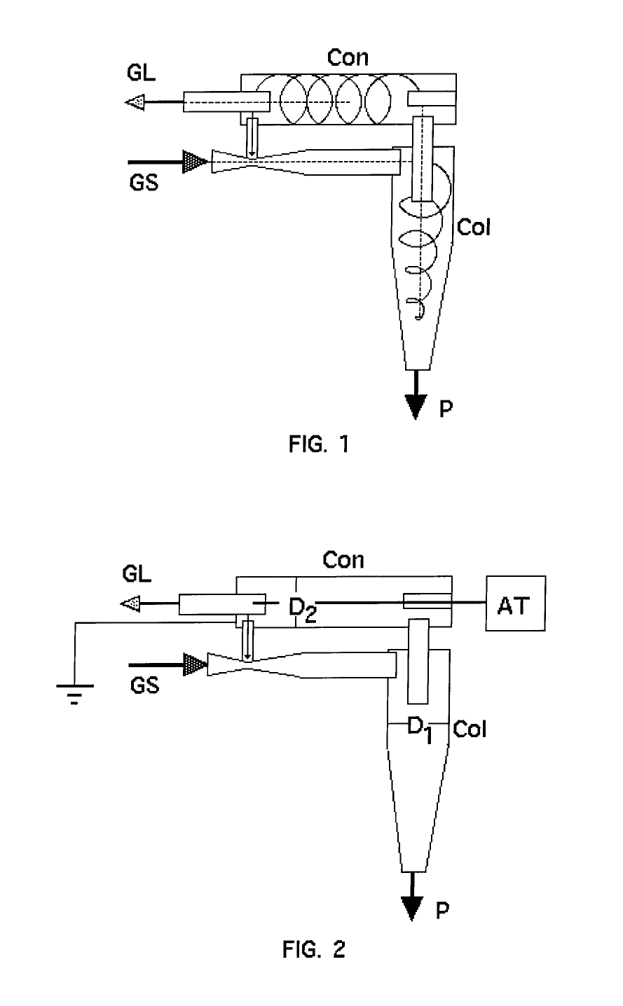

FIG. 1 is a schematic representation of a cyclone system with purely mechanical recirculation is comprised of a reverse-flow cyclone called a collector (Col), of a straight-through cyclone called a concentrator (Con), located downstream, and of a recirculation system with a blower, venturi or ejector, as described in the state-of-the-art.

FIG. 2 is a schematic representation of the device according to the invention comprising a reverse-flow cyclone called a collector (Col), a straight-through cyclone called a concentrator or electrostatic recirculator (Con), located downstream, electrified by a high voltage dc power supply (AT) (with reference to the nominal diameters of the collector and concentrator (Di, D₂)), and a recirculation system, which can be a blower, venturi or ejector. Such representation serves merely the purpose of exemplification and should not be limitative, and one can see where the dirty gas enters (GS), where the captured particles exit (P), and where the cleaned gas exits (GL).

It has been discovered that the main difference between the invention and cyclones, with recirculation of the state-of-art (with purely mechanical recirculation) as shown in FIG. 1, is the electrification of the concentrator. However, the voltage (AT) applied to the discharge electrode, the diameter of the discharge electrode, and the distance between it and the concentrator wall, are all combined to originate a current density below approximately 0.1 mA/m². This confers characteristics to the device completely different from ones of a conventional ESP.

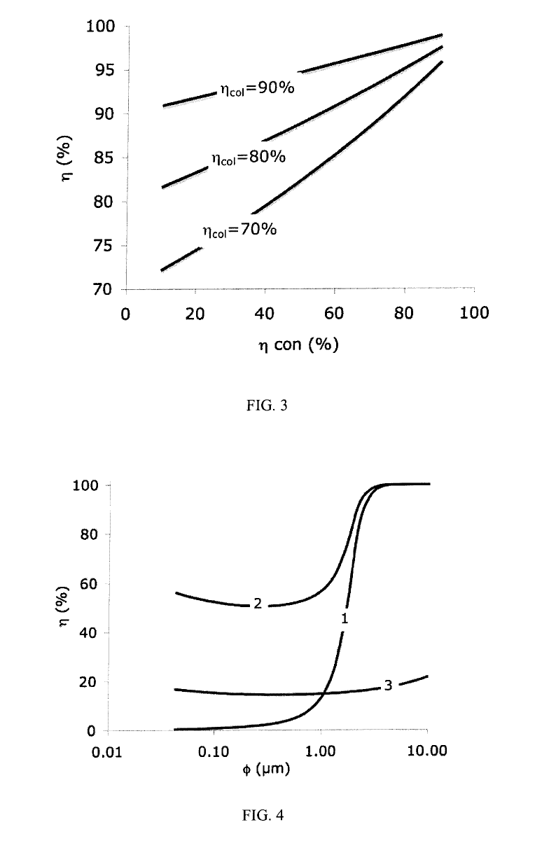

The concept of the invention is depicted in FIGS. 3 and 4. FIG. 3 shows a graph of global efficiencies (η) for the system of FIG. 2, showing that the efficiency of the system is always larger than that of the stand-alone collector (ηcoi) and that increasing the concentrator efficiency (η_{c}on) will increase the system efficiency (η). FIG. 4 shows a graph of grade-efficiencies (efficiency depending on particle size [diameter (φ)] for the concentrators of FIGS. 1 and 2 (curves 1 and 2 respectively)) showing that the electrostatic recirculation efficiency (η) is much superior to the purely mechanical recirculation efficiency (η), while particle deposition on the walls (η) for fine particles is negligible (curve 3). This figure was obtained through simulation, using results obtained experimentally in a full-scale facility with mechanical recirculation, and extrapolating for electrostatic recirculation using appropriate theories (Salcedo, 1981).

It is established through FIG. 4, that with an electrostatic concentrator according to the invention (also called herein electrostatic recirculator), particle deposition on the walls is very low for fine particles (curve 3), which are the ones escaping from the collector cyclone and entering the concentrator, and that there is a remarkable increase in recirculation efficiency back to the reverse-flow cyclone. The electrostatic recirculation efficiency (curve 2) is much superior to the purely mechanical one (curve 1), especially for submicrometer particles, thus increasing the term η_{con}, in Eq. [I].

FIG. 3 in turn shows the beneficial effect of increasing the term η_{con} in the global efficiency η.

The proposed concept of electrostatic recirculation, which apparently resembles ESPs when schematically shown (FIG. 2), presents considerable differences in relation to conventional ESPs, even if using one device (i.e., the electrostatic recirculator). These differences are apparent from curve 3 of FIG. 4. Other differences are:
1. Tubular ESPs are vertical, so that particles captured on the walls may be removed through the base. The proposed recirculator may be oriented in any position, including horizontal, since it is not intended to operate as a particle collector.
2. Tubular ESPs have a system for vibrating, hammering, or washing the walls, to remove deposited particles. Such is not the case for the proposed concentrator, since it does not need any dust layer removal device.
3. Tubular ESPs have dust hoppers to collect particles dislodged from their walls. The proposed concentrator does not need any hopper, since it is not a collector (this task is left to the reverse-flow cyclone located upstream from the concentrator).
4. Tubular ESPs operate with high electric fields (>5×IO⁵ V/m) so that current density is high (>1 mA/m²), leading to a large migration rate (w) of particles towards the collection electrode (<<0.1-1 m/s for particle diameters between 0.1-10 μm) and large collection efficiencies (>95%). This is achieved by spacing apart the electrodes over a distance of around 200 mm (typically between 150-250 mm/Parker, 1997) for applied maximum voltages in the order of 60-70 kV. Such is not the case with the proposed recirculator, in which the spacing apart distance between the electrodes is very large (<<450-600 mm). With maximum applied voltages in the order of 50 kV, the electric field produced is low (<2×IO⁵ V/m), with low current densities (<0.1 mA/m²) originating low migration velocities of particles toward the walls (<<0.01-0.05 m/s for particle diameters between 0.1-10 μm), and very low particle deposition on the walls (ideally, particle deposition on recirculator walls should be zero). If the electrostatic component of the electrostatic recirculator malfunctions, mechanical recirculation is still operational. On the contrary, failure of the electrified fields in ESPs completely compromises the efficiency of these devices and their use as particles removers.

Table I, below, summarizes these differences.

TABLE I
Significant differences between tubular ESP (Parker, 1997)
and electrostatic recirculator according to the invention

| | | | | Inter- | Average |
|---|---|---|---|---|---|
| | | | | electrode | Electric |
| | | | Particle | Spacing | Field |
| Type | Orientation | Hopper | Removal | mm | V/m |
| Tubular ESP | Vertical | Yes | Hammer | 150-250 | >5 × 10⁵ |
| | | | Vibration | (200) | |
| | | | Washing | | |
| Electrostatic | Any | No | No | 450-600 | <2 × 10⁵ |
| Recirculator | | | | | |

| | | Migration | Sensitivity to |
|---|---|---|---|
| | | Velocity | very low or |
| | Current | (w) | high particle |
| | Density | (*) | resistivity |
| Type | mA/m² | m/s | Ohm · m |
| Tubular ESP | >1 | 0.1-1 | High for range |
| | | | (<10⁶ or >10⁹) |
| Electrostatic | <0.1 | 0.01-0.05 | None |
| Recirculator | | | |

| | | Typical |
|---|---|---|
| | Sensitivity | Removal |
| | to High | Efficiency |
| | Voltage | (**) |
| Type | Shutdown | % |
| Tubular ESP | Fatal | >95 |
| Electrostatic | Low | |
| Recirculator | (mechanical | <10 |
| | recirculation | |
| | in operation) | |

(*) - for particle diameters between 0.1-10 μm
(**) - for particle size distributions emitted by biomass boilers (wood waste)

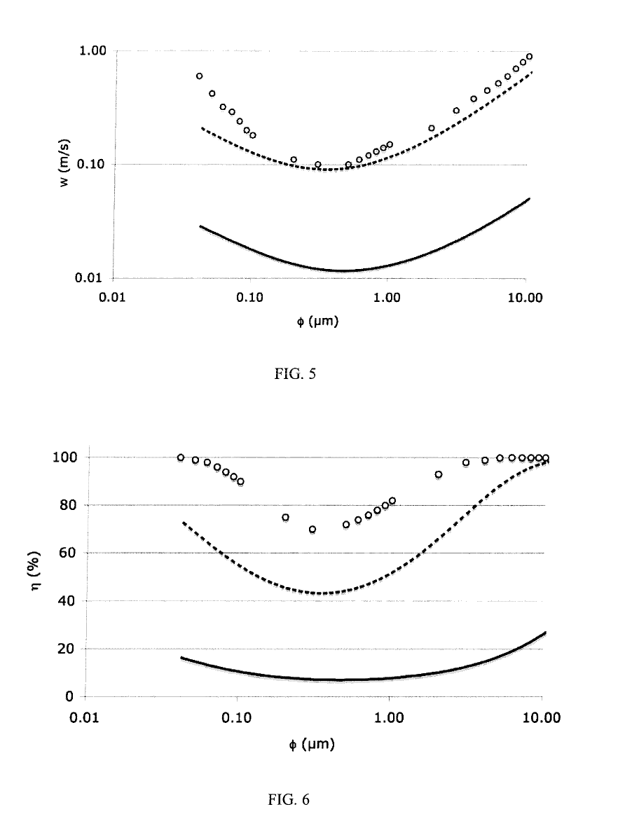

FIG. 5 shows that, for the electrostatic concentrator, the particle migration velocity (w) towards the walls for a wide range of particle diameters (φ) only has values close to those obtained with ESPs if the applied voltage is over 200 kV.

FIG. 6 shows that, for the electrostatic concentrator; the particle retention efficiency (η) on the walls (which in the case of the invention should be minimized), depending on their size [diameter (φ)], only has values close to those obtained with ESPs if the applied voltage is over 200 kV.

In FIGS. 5 and 6, dots represent typical values for ESPs (Parker, 1997). The continuous curve represents the device according to the invention when operating at 50 kV, and the interrupted curve represents the tension of about 200 kV that would be necessary to apply (simulation) to the device according to the invention to bring its behaviour close to that of conventional ESPs, both in terms of particle migration velocity and particle collection efficiency on the walls, respectively.

Said FIGS. 5 and 6 show that, to obtain migration velocities (w) and collection efficiencies (η) typical of ESPs (Parker, 1997), it would be necessary to operate the recirculator proposed in the invention at about 200-300 kV. Such extreme voltages are never used in ESPs due to cost and safety reasons. On the other hand, the differences between the device according to the invention (in which the recirculator is electrified) and the electrified collectors (inverted reverse-flow cyclones) from the state-of-art are shown in Table II below. Table II presents the cyclone diameters and corresponding volumes necessary to have a discharge wire length measured between the lower end of the vortex tube and the beginning of the cone of 2.7 m, which is considered a typical value occurring in an electrostatic concentrator (recirculator) according to the invention and designed for industrial applications when considering an electrostatic concentrator with nominal diameter (D₂) of 0.6 m and corresponding volume of 1.13 m³.

TABLE II
Nominal diameter and volume for 3 types of cyclones with
a discharge wire of 2.7 m

| | Diameter | Volume |
|---|---|---|
| Type of Cyclone | (m) | (m³) |
| Lapple (low | 1.964 | 12 |
| efficiency) | | |
| Stairmand_HE (high | 2.700 | 31 |
| efficiency) | | |
| EP0972572 (very high | 5.050 | 154 |
| efficiency) | | |

The volume necessary to maintain the electrostatic effect increases drastically when changing from low to high and very-high efficiency cyclones. The coupling in a reverse-flow cyclone between purely mechanical capture and mixed mechanical-electrical capture is not industrially practical because the cyclones would be huge or mechanically inefficient, thus making them similar to purely ESPs.

As explained before, the concentrator (electrostatic recirculator) according to the invention, is either partially or totally crossed on its length by an electrode or a system of discharge electrodes, connected to a high voltage supply and properly electrically insulated. The discharge only occurs at the concentrator (recirculator) and its walls. The reverse-flow collector cyclone and connective piping should be appropriately grounded. The three components are connected as follows: the gas to be treated or cleaned enters the reverse-flow cyclone where a fraction of particles are caught. The particles escaping collection enter (along with the total gas flow) the concentrator cyclone (electrostatic recirculator) where a small fraction of the gas with a substantial fraction of the uncollected particles is recirculated back to the reverse-flow cyclone through the blower, venturi or ejector. Said substantial fraction of the uncollected particle is concentrated more efficiently by applying an ionized electric field in the concentrator, as opposed to a purely mechanical recirculation. The concentrator should operate at an applied voltage that allows for some electric current between the discharge electrodes and its walls while particle deposition on the recirculator walls should be minimized. Such is obtained for current densities of about 0.1 mA/m² or below.

To better understand these phenomena, the proposed system was modeled using a computer program based on the finite diffusivity theory of Mothes and Loffler (1988), which is the best theory currently available (on a diagnosis level) for the simulation of particle capture in reverse-flow cyclones. Since this model requires knowledge about the particle turbulent dispersion coefficients, these were obtained using an adequate correlation (Salcedo and Coelho, 1999). FIG. A shows the predicted grade-efficiency curves (efficiency depending on particle size) for the proposed system at industrial scale when compared to the all-mechanical recirculator. Both treat the same gas flowrate and particles. A significant increase in recirculation efficiency is obtained for most of the smaller particles. This causes the system's global efficiency to increase significantly. For example, using the same data used in FIG. 4, it is predicted that simply with mechanical recirculation, the global efficiency (η) is about 83.2%, while with electrostatic recirculation it would be about 94.7%, thereby leading to emission reductions of 68%.

As the electrostatic effect in the recirculator is favoured by a longer particle charging time, it is better to operate the system at low gas velocities so that the total pressure drop, and consequently the operating costs, are reduced compared to the all-mechanical recirculation system. The use of a venturi for recirculation allows for use at very high temperatures, provided that the gas flowrate is not too high. For higher gas flowrates, one may use appropriate ejectors or a secondary blower. These systems may also be used for economically dry cleaning of acid gases, since they will partially recirculate the solid reactant (partially converted to solid product) back to the reverse-flow cyclone.

Efficient processes for dedusting flue gases and/or dry cleaning of gaseous components of flue gases, especially, acid gases such as HCl (hydrogen chloride), HF (hydrogen fluoride), SO₂ (sulfur dioxide) and NO (nitrogen oxides), are obtained by making these gaseous streams traverse a cyclone system with cyclones in a series, where the collector precedes the electrified concentrator, and where there is a recirculation loop from the concentrator back to the collector, and in the case of dry gas cleaning, an injection (not shown in the figures) of an appropriate solid sorbent (e.g. in finely divided form) upstream from the collector or from the recirculation blower, venturi or ejector.

As previously shown, the efficiency of the system according to the present invention is always larger than the efficiency of the devices of the state-of-art (FIGS. 3 and 4), where the recirculator is not electrified. The practical examples given below will corroborate the increase in efficiency (FIGS. 7-9).

Due to the efficient recirculation loop, the system according to the invention may also be used with great advantage to substitute reactors presently used (e.g., spray-dryer or venturi rectors) for dry cleaning of acid gases, and makes it possible to design extremely compact and highly efficient units, both for acid gas removal and for the use of unreacted sorbent.

The system according to the invention also has the following advantages:
The electrostatic recirculator may be used in any orientation, even horizontally;
There is no need for complicated systems for particle removal from its walls, since the deposition is intrinsically minimized: by, inter alia, the high interelectrode spacing apart that is characteristic of the device according to the invention;
There is no need for dust hoppers in the recirculator, since the collector is a reverse-flow cyclone;
Uses voltage levels commonly used in ESPs, or even lower;
Does not suffer from problems related either to low or high dust resistivity;
Has the capability of recirculation through blower, venturi or ejector;
Has the capability of removing particles and/or dry cleaning acid gases from flue gases;
Has the capability of operating at very high temperatures, through the use of a venturi or ejector for recirculation;
It has no moving parts, in the case of recirculation provided by a venturi or ejector; and
Acts as an all-mechanical recirculation cyclone system, in the event of high-voltage failure (e.g. discharge electrode rupture).

### Practical Examples

A pilot-scale unit was built to demonstrate the capability of electrostatic recirculation of the system through the use of a blower for promoting mechanical recirculation and a high-voltage source for promoting electrostatic recirculation.

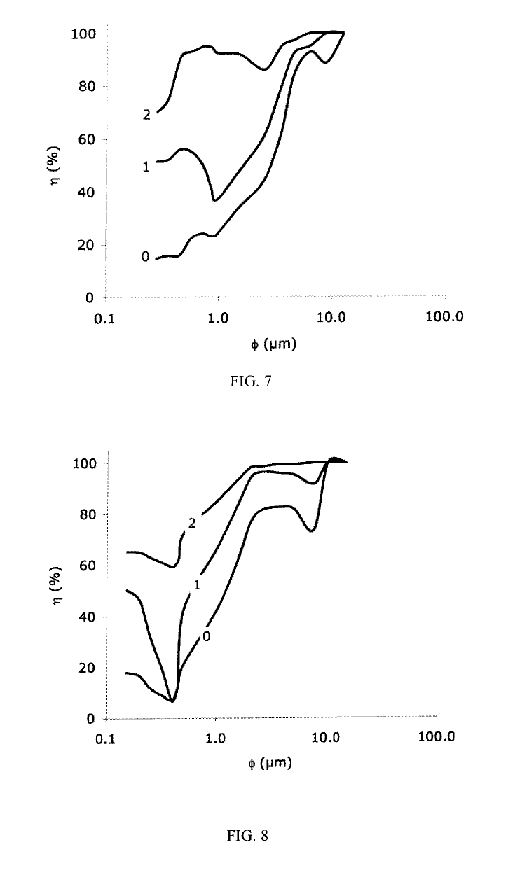

FIGS. 7-8 show, depending on particle diameter [diameter φ], the efficiencies (η) obtained at pilot scale, respectively for the stand-alone cyclone (curve 0), for the all-mechanical recirculation (curve 1), and for the electrostatic recirculation (curve 2), for two extreme conditions: a very low pressure drop in the cyclone (400 Pa) [FIG. 7], and a typical pressure drop in the cyclone (1620 Pa) [FIG. 8].

Such figures, representing data obtained by feeding the cyclone with very thin airborne particles (mass median from 1.8 to 2.3 μm), show that the global efficiency of the system with electrostatic recirculation (curve 2) is always significantly larger than that with an all-mechanical one; however, especially for a low pressure drop in the cyclone, that is for low velocity which corresponds to high residence time. In other words, the electrostatic recirculation is mostly better than all-mechanical recirculation in situations where the all-mechanical recirculation is less efficient.

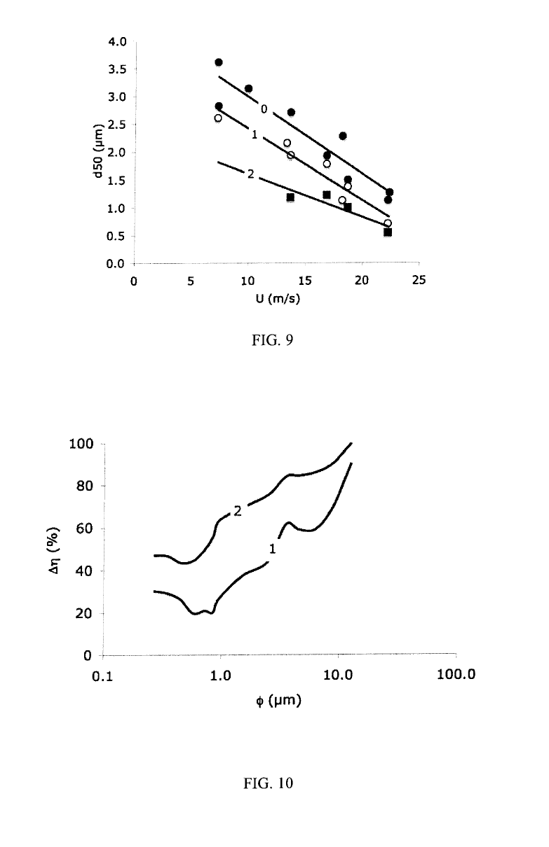

FIG. 9 shows the cyclone cut-diameters (d50), depending on the average air velocity (U) entering the cyclone, for three situations: filled dots (curve 0) represent the standalone collector cyclone; hollow dots (curve 1) represent the mechanical recirculation; and squares (curve 2) represent the additional electrostatic recirculation.

This figure shows the difference in the cyclone cut diameters (particle diameters for which cyclone efficiency is 50%), for the same particles when mechanical (1) or electrostatic (2) recirculation is applied. Electrostatic recirculation is clearly more advantageous, presenting smaller cut diameters for the same entrance velocity of gas in the cyclone.

FIG. 10 shows the average increase in particle capture efficiency (Δη) obtained at pilot-scale, depending on particle size [diameter (φ)], when all-mechanical recirculation (curve 1) or electrostatic recirculation (curve 2) is applied. This figure shows the average increase in efficiency of a series of runs over that of the stand-alone collector cyclone. Once more, electrostatic recirculation (2) represents a marked increase in efficiency over all-mechanical recirculation (1). Experiments made with industrial fly ash emitted from wood and cork waste boilers confirm the results obtained with airborne particles.

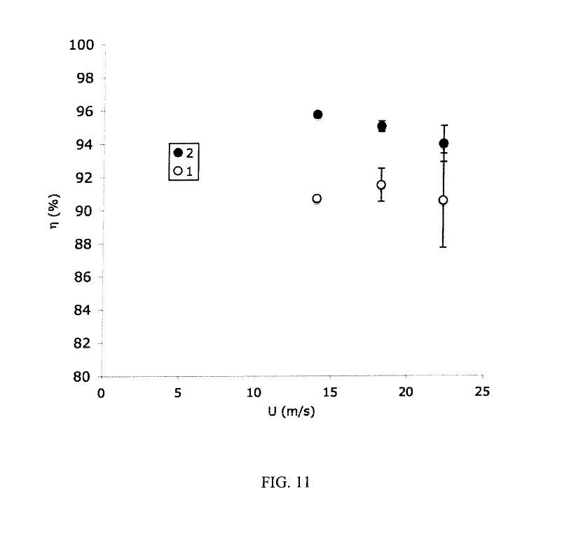

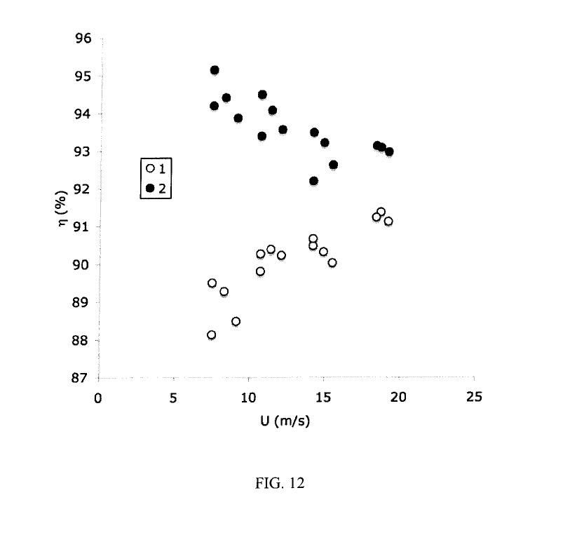

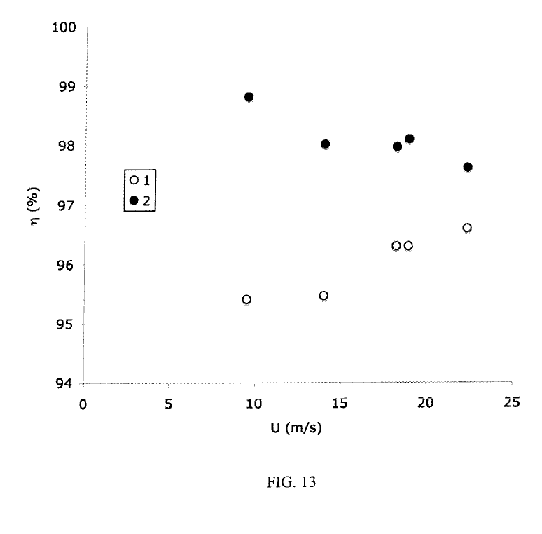

FIG. 11 shows the efficiency (η) for dicalcium phosphate particles with a median volume diameter of 6.2 μm, with all-mechanical recirculation (hollow dots, 1), and with electrostatic recirculation (filled dots, 2), for various velocities (U) of the flue gas. FIG. 12 shows the efficiency (η) for iron ore blast furnace particles with a median volume diameter of 7.5 μm, with all-mechanical recirculation (hollow dots, 1), and with electrostatic recirculation (filled dots, 2), for various velocities (U) of the flue gas. FIG. 13 shows the efficiency (η) for phosphorite particles with a median volume diameter of 13.2 μm, with all-mechanical recirculation (hollow dots, 1), and with electrostatic recirculation (filled dots, 2), for various velocities (U) of the flue gas. Therefore, it has been established that the proposed system can significantly reduce particulate emissions when compared to reverse-flow cyclones or other recirculation systems with the concentrator upstream or downstream from the collector. The use of very high efficiency designs for the collector (viz. the design described in said patent EP0972572) allows the proposed system to compete in efficiency with more costly equipment (scrubbers, Venturis, bagfilters and ESPs), even in terms of particle sizes below approximately 0.5 μm. Furthermore there is the additional advantage of operation at very high temperatures, and for the dry cleaning of acid gases by employing an appropriate dry sorbent injection, in particular powders.

The development of dedusters with efficiencies significantly above those of current cyclones or recirculation cyclone systems, using simple and inexpensive technologies, mainly for particle sizes below 2-3 μm in diameter, has a great potential for industrial usage. Several industries (wood, metals, cement, chemical, solid-fuel and biomass boilers) could benefit from low cost devices and with sufficient efficiency to avoid the need to use more expensive dedusters, such as bagfilters and ESPs. Likewise, the automotive industry, in its search for cleaner emissions from diesel engines could benefit from a device such as that proposed here, usable at high temperatures and without any moving parts. The proposed system can also be used with great advantage, as opposed to the presently available reactors for the dry cleaning of acid gases, such as HCl, HF, SO2 and NOₓ (nitrogen oxides). With the proposed system, it is possible to design very compact units with high collection efficiency, both in removing acid gases and in the reuse of unspent sorbent due to the electrostatic recirculation loop.

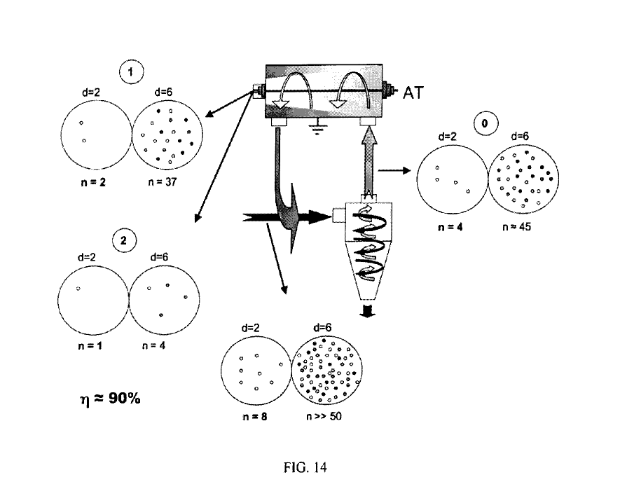

Finally, as seen in FIG. 14, the device and process according to the invention are so efficient in capturing small particles that they can be used, for example, for capturing airborne bacteria. FIG. 14 shows, very schematically, the comparative result in capturing airborne bacteria based on the counting of colony forming units at the end of two (d=2) and six (d=6) days. FIG. 14 compares a pilot electrostatic recirculation system operating at 50 kV, according to the invention (2), an all-mechanical recirculation system (1), and a stand-alone cyclone (0), to a sample of fresh air entering the system. The number of cfu shown in the figure is given by the value of n, one cfu being one colony-forming unit.

It has been established that there is a (bacteria) capture efficiency of approximately 90% deriving from the fact that there are 8 colonies entering the system (fresh air) after 2 days of incubation, and only one exiting (with electrostatic recirculation), resulting in η=87.5%. Furthermore, there are more than 50 colonies entering the system after 6 days of incubation, and only 4 exiting, resulting in η>92.0%, representing an (approximate) average efficiency value of 90%.

There is a further embodiment of the invention that is not shown in the figures, and that is characterized in that, in parallel with the straight-through cyclone concentrator (recirculator, Con) having the electrical means for providing an ionizing high tension (AT), there are other straight-through concentrator cyclone(s) (recirculator(s)) having the electrical means for providing an ionizing high tension. This constitutes a parallel multi-electrostatic recirculator arrangement where all are fed by the same reverse-flow cyclone (Col) placed upstream from such arrangement and recirculating a fraction of the respective gaseous stream (concentrated in particles) back to this cyclone collector. This parallel arrangement of recirculators lowers the velocity in each recirculator, providing for added residence time and added charging of the particles (FIG. 11-13; filled circles (2)).

Another embodiment of the invention, which is also not represented in the Figures, is characterized in that, in a series with the straight-through concentrator cyclone (recirculator, Con) having the electrical means for providing an ionizing high tension (AT), there are other straight-through concentrator cyclone(s) (recirculator(s)) having the electrical means for providing an ionizing high tension. This constitutes a serial multi-electrostatic recirculator arrangement where all are fed by the same reverse-flow cyclone (Col) placed upstream from such arrangement, each concentrator recirculating a fraction of the gaseous stream (concentrated in particles) back to this collector cyclone. This serial arrangement of recirculators provides for added residence time and added charging of the particles (FIG. 11-13; filled circles (2)).

In this document, the use of the expression “about” or “approximately” when specifying the limit values for intervals referring to the invention, must be considered as comprising a 10% variation on those same limits, such that the interval broadens.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

### REFERENCES

Carminati, A., A. Lancia, D. Pellegrini and G. Volpiccelli, “Spray dryer absorption of HCl from flue gas”, Proc. 7^{th} World Clean Air Congr., 426, 1986.
A. M. Fonseca, J. M. órfao and R. L. Salcedo, ̂Dry-scrubbing of HCl with solid lime in a cyclone reactor at low temperatures”, Ind. Eng. Chem. Res., 40, no. I, 304-313, 2001. Heap, B. M., “The continuing evolution and development of the dry scrubbing process for the treatment of incinerator flue gases”, Filtr. Sep., vol. 33, 375, 1996.
Licht, W., “Air Pollution Control Engineering-basic calculations for particulate collection”, Marcel Dekker, New York and Basel, 1980.
Lim, K. S., K. W. Lee and M. R. Kuhlman, ^{M}An experimental study of the performance factors affecting particle collection efficiency of the electrocyclone”, Aerosol Science and Technology, 35, 969-977, 2001. Lim, K. S., H. S. Kim and K. W. Lee, “Comparative performances of conventional cyclones and a double cyclone with and without an electric field”, J. Aerosol Science, 35, 103-116, 2004.
Mothes, H. and F. Loftier, “Prediction of particle removal in cyclone separators”, International Chemical Engineering, vol. 28, 231-240, 1988.
Oglesby, S. Jr. and G. B. Nichols, “Electrostatic Precipitation”, Marcel Dekker, Inc., 1978.
Parker, K. R., “Applied Electrostatic Precipitation”, Blackie Academic & Professional, 1997.
Salcedo, R. L. R., “Chemical separation in electrostatic precipitators”, Ph.D. Thesis, McGill University, Montreal, Canada, 1981.
Salcedo, R. L. and M. A. Coelho, “Turbulent Dispersion Coefficients in Cyclone Flow: an empirical approach”, Can. J. Chem. Eng., Agosto, 609-616, 1999.
Salcedo, R. L. and M. J. Pinho, “Ciclones de muito elevada eficiencia: da concepçao a implementagao industrial”, Ingenium, 2^{a} serie, no 69, Setembro, 79-82, 2002.
Salcedo, R. L. and M. J. Pinho, “Pilot and Industrial-Scale Experimental Investigation of Numerically Optimized Cyclones”, Ind. Eng. Chem. Res., 42, no. I, 145-154, 2003.
Salcedo, R. L. and M. de Sousa Mendes, “Captura de poeiras finas corn ciclones optimizados: estudo de dois casos industrials”, Industria e Ambiente, no 30, 2° trimestre, 18-22, 2003.
Salcedo, R. L. R., V. G. Chibante and I. Sōro, “Laboratory, pilot and industrial-scale validation of numerically optimized reverse-flow gas cyclones”, Trans, of the Filt. Soc. 4(3), 220-225, 2004.
Shrimpton, J. S, and R. I. Crane, “Small electrocyclone performance”, Chem. Eng. Technology, 24(9), 951-955, 2001. White, H. J., “Industrial Electrostatic Precipitation”, International Society for Electrostatic Precipitation, Addison-Wesley Publ. Co., 1963.

What is claimed is:

1. Cyclones with electrostatic recirculation for dedusting and dry gas cleaning, comprising a reverse-flow collector cyclone (Col) upstream from a straight-through concentrator cyclone (Con) having one central channel for cleaned gas exhaustion (GL), these cyclones being placed in series and having a recirculation line from the concentrator to the collector, for a fraction of the gas to be treated, characterized in that, in the recirculator, there are electrical means for applying high voltage (AT) to form an ionized electric field imparting a charge on the particles inside the recirculator, making them travel away from the central exhaust channel, but without any significant particle deposition on the recirculator walls.

2. Cyclones with electrostatic recirculation according to claim 1, characterized in that the electrical means for applying high tension (AT) are comprised of discharge electrode(s) placed according to the longitudinal axis of the recirculator, electrically insulated from the wall of the recirculator, which is grounded so that a large potential difference establishes between the wall and said discharge electrode(s), the voltage applied to the discharge electrode(s), the shape and diameter of the discharge electrode (s) and the spacing apart between the electrode (s) and the wall of the concentrator (Con), being combined so that a current density below about 0.1 mA/m² is generated.

3. Cyclones with electrostatic recirculation according to claims 1, characterized in that the means for applying high tension (AT) form an ionized electric field in the recirculator (Con) with an average value below about 2×IO⁵ V/m.

4. Cyclones with electrostatic recirculation according to claims 1, characterized in that the recirculation of flue gases is made by a blower, ejector or venturi.

5. Cyclones with electrostatic recirculation according to claim 1, characterized in that, in parallel with the straight-through concentrator cyclone (recirculator, Con) having the electrical means for providing an ionizing high tension (AT), there is (are) other straight-through concentrator cyclone(s) (recirculator (s)), having electrical means for providing an ionizing high tension, defining a parallel multi-electrostatic recirculator arrangement, where all are fed by the same reverse-flow collector cyclone (Col), placed upstream from such arrangement, and recirculate a fraction of the respective gaseous stream with concentrated particles back to said collector cyclone.

6. Dedusting process of a gaseous stream, where such stream first enters a reverse-flow cyclone collector (Col), where part of the particles of such gaseous stream are captured (P) and then enters a straight-through concentrator cyclone (recirculator, Con), having a central channel for the exhaust of cleaned gases (GL), and where part of the particles remaining in the gas stream are concentrated and recirculated with part of the gas back to said collector cyclone, characterized in that the particles in the recirculator (Con) are directed away from the central exhaust channel by the joint action of mechanical (inertial) and electrical forces, where these last ones are produced by the particles traversing a high voltage ionized electric field, thus providing the particles concentration, without any appreciable deposition on the concentrator walls, in the gas recycled back to the cyclone collector where part of the recirculated particles are captured.

7. The process according to claim 6, characterized in that the electric field strength in the recirculator (Con) is lower than about 0.1 mA/m².

8. The process according to claim 6, characterized in that the (average) current density in the recirculator (Con) is lower than about 2×IO⁵ V/m.

9. The process according to claim 6, characterized in that the fraction of recirculated gas from the concentrator (Con) to the collector (Col) is about 20 to 30% of the total entering the collector.

10. The process for dedusting and dry gas cleaning, according to claim 6, characterized in that there is an injection of solid sorbent for dry gas cleaning, upstream from the collector (Col), or upstream from the recirculation blower, venturi or ejector.

11. Cyclones with electrostatic recirculation according to claim 1, characterized in that the cyclones are employed for dedusting and dry gas cleaning of acid gases, comprising HCl (hydrogen chloride), HF (hydrogen fluoride), SO₂ (sulfur dioxide) and NOₓ (nitrogen oxides).

12. The process according to claim 6, characterized in that the process is employed for dedusting and dry gas cleaning of acid gases, comprising HCl (hydrogen chloride), HF (hydrogen fluoride), SO₂ (sulfur dioxide) and NOₓ (nitrogen oxides).

13. Cyclones with electrostatic recirculation according to claim 1, characterized in that the cyclones are employed for dedusting exhaust gases from diesel engines.

14. The process according to claim 6, characterized in that the process is employed for dedusting exhaust gases from diesel engines.

15. Cyclones with electrostatic recirculation according to claim 1, characterized in that the cyclones are employed for capturing bacteria from a gas flow.

16. The process according to claim 6, characterized in that the process is employed for capturing bacteria from a gas flow.
